(19) United States
(12) Patent Application Publication
(10) Pub. No.: US 2026/0311441 A1
(43) Pub. Date: Oct. 8, 2026

(54) METHOD, APPARATUS, ELECTRONIC DEVICE, AND STORAGE MEDIUM FOR INTERACTION

(71) Applicant: Beijing Youzhuju Network Technology Co., Ltd., Beijing (CN)

(72) Inventor: Lili Li, Beijing (CN)

(21) Appl. No.: 19/483,226

(22) PCT Filed: Aug. 27, 2024
(86) PCT No.: PCT/CN2024/114943

§ 371 Date: Nov. 10, 2025

(30) Foreign Application Priority Data
Aug. 28, 2023 (CN) 202311094481.2

(51) Int. Cl. G06T 19/20

(52) U.S. Cl. CPC G06T 19/20; G06T 2200/24; G06T 2210/16; G06T 2219/2016

(57) ABSTRACT

Embodiments of the disclosure provide a method for interaction and apparatus, an electronic device, and a storage medium. The method includes: displaying target media content on a media content display page; in response to a try-on operation for a target object in the target media content, obtaining first appearance information to be tried on, and obtaining a first human body model whose appearance information matches the first appearance information, where the target object is a recommended object of the target media content; and displaying the first human body model on the media content display page, where the first human body model wears the target object.

The present application claims priority to Chinese Patent Application No. 202311094481.2, filed on Aug. 28, 2023, and entitled “METHOD, APPARATUS, ELECTRONIC DEVICE, AND STORAGE MEDIUM FOR INTERACTION”, which is incorporated herein by reference in its entirety.

### FIELD

Embodiments of the present disclosure relate to the field of computer technologies, and in particular, to a method, an apparatus, an electronic device, and a storage medium for interaction.

### BACKGROUND

In the prior art, a user may view commodity information on a detail page of a commodity. However, the commodity information is displayed in a relatively monotonous manner.

### SUMMARY

Embodiments of the present disclosure provide a method, an apparatus, an electronic device, and a storage medium for interaction to enrich display manners of commodity information.

In a first aspect, an embodiment of the present disclosure provides a method for interaction. The method includes: displaying target media content on a media content display page; obtaining first appearance information to be tried on in response to a try-on operation for a target object in the target media content, and obtaining a first human body model whose appearance information matches the first appearance information, where the target object is a recommended object of the target media content; and displaying the first human body model on the media content display page, where the first human body model wears the target object.

In a second aspect, an embodiment of the present disclosure further provides an apparatus for interaction. The apparatus includes: a media content display module configured to display target media content on a media content display page; a model obtaining module configured to obtain first appearance information to be tried on in response to a try-on operation for a target object in the target media content, and obtain a first human body model whose appearance information matches the first appearance information, where the target object is a recommended object of the target media content; and a model display module configured to display the first human body model on the media content display page, where the first human body model wears the target object.

In a third aspect, an embodiment of the present disclosure further provides an electronic device. The electronic device includes: one or more processors; and a memory configured to store one or more programs, where the one or more programs, when executed by the one or more processors, cause the one or more processors to implement the method for interaction according to the embodiments of the present disclosure.

In a fourth aspect, an embodiment of the present disclosure further provides a computer-readable storage medium having a computer program stored thereon, and the computer program, when executed by a processor, causes the method for interaction according to the embodiments of the present disclosure to be performed.

### BRIEF DESCRIPTION OF DRAWINGS

The above and other features, advantages, and aspects of the embodiments of the present disclosure will become more apparent in combination with the drawings and with reference to the following specific implementations. Throughout the drawings, the same or similar reference numerals denote the same or similar elements. It should be understood that the drawings are schematic, and parts and elements are not necessarily drawn to scale.

FIG. 1 is a schematic flowchart of a method for interaction according to an embodiment of the present disclosure;

FIG. 2 is a schematic diagram illustrating target media content according to an embodiment of the present disclosure;

FIG. 3 is a schematic diagram illustrating an appearance information input panel according to an embodiment of the present disclosure;

FIG. 4 is a schematic diagram illustrating a first human body model according to an embodiment of the present disclosure;

FIG. 5 is a schematic flowchart of a method for interaction according to a further embodiment of the present disclosure;

FIG. 6 is a schematic diagram illustrating a candidate appearance panel according to an embodiment of the present disclosure;

FIG. 7 is a block diagram of an apparatus for interaction according to an embodiment of the present disclosure; and

FIG. 8 is a schematic structural diagram of an electronic device according to an embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein; on the contrary, these embodiments are provided for more thorough and complete understanding of the present disclosure. It should be understood that the drawings and embodiments of the present disclosure are only for exemplary purposes and are not intended to limit the protection scope of the present disclosure.

It should be understood that steps described in method implementations of the present disclosure may be performed in different orders and/or in parallel. Furthermore, the method implementations may include additional steps and/or omit the steps shown. The scope of the present disclosure is not limited in this respect.

The term “include/comprise” and its variants used herein are open-ended inclusions, that is, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of other terms will be given in the following description.

It should be noted that concepts such as “first” and “second” mentioned in the present disclosure are only used to distinguish different apparatuses, modules, or units, and are not used to limit the order or interdependence of the functions performed by these apparatuses, modules, or units.

It should be noted that the modifiers “a” and “a plurality of” mentioned in the present disclosure are illustrative rather than restrictive, and those skilled in the art should understand that unless otherwise explicitly specified in the context, they should be understood as “one or more”.

The names of messages or information exchanged between apparatuses in the implementations of the present disclosure are only for illustration, and are not intended to limit the scope of these messages or information.

It may be understood that before the use of the technical solutions disclosed in the embodiments of the present disclosure, the user should be informed of the type, range of use, use scenarios, etc., of personal information involved in the present disclosure in an appropriate manner and the authorization of the user should be obtained in accordance with relevant laws and regulations.

For example, in response to receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other manners that satisfy the relevant laws and regulations may also be applied to the implementations of the present disclosure.

It may be understood that the data involved in the technical solution (including but not limited to the data itself, acquisition or use of the data) should comply with the requirements of corresponding laws, regulations, and related provisions. In addition, in the collection and use of data, the user's personal information will not be collected or will be processed in a manner that does not expose the user's identity.

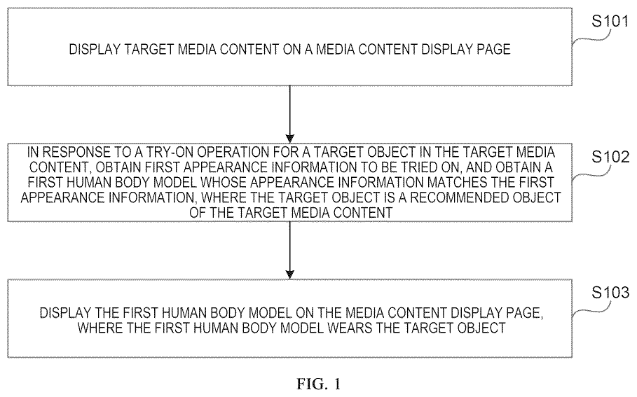

FIG. 1 is a schematic flowchart of a method for interaction according to an embodiment of the present disclosure. The method may be performed by an apparatus for interaction, where the apparatus may be implemented in software and/or hardware, may be configured in an electronic device, and typically may be configured in a mobile phone or a tablet computer. The method for interaction provided by the embodiment of the present disclosure may be applicable to the scenario of trying on, in a media content display page, an item recommended in media content. As shown in FIG. 1, the method for interaction provided by the embodiment of the present disclosure may include steps S101, S102, and S103.

At block S101, target media content is displayed on a media content display page.

In some embodiments, the media content display page may be a page for displaying media content, such as a page for displaying media content in a media content stream. For example, the media content display page may be a recommended media content display page for displaying recommended media content. The target media content may be media content currently displayed on the media content display page, which may be, for example, media content with a corresponding recommended object, such as advertising media content or product-promotion media content for a recommended object. The type of the target media content is not limited. For example, the target media content may be video, pictures and texts, or a combination of both, including images of the recommended object. Alternatively, it may be a three-dimensional image of the recommended object, such as a three-dimensional model of the recommended object.

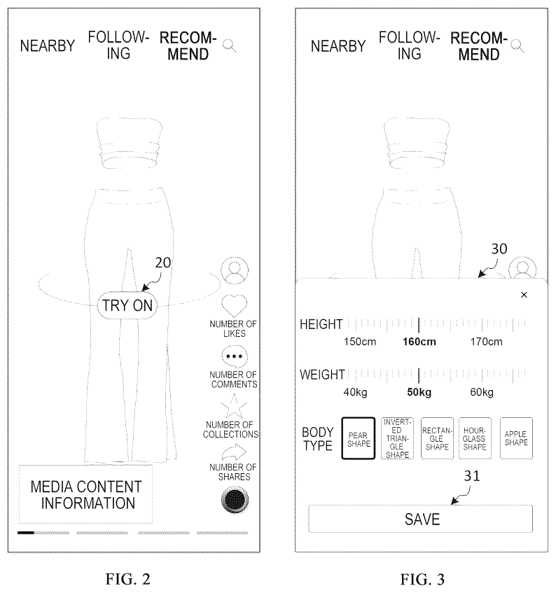

As an example, media content may be displayed on the media content display page. For example, target media content with a corresponding recommended object may be displayed on the media content display page, as illustrated in FIG. 2 (the example in FIG. 2 illustrates displaying the recommended target media content on the recommended media content display page, with the target object recommended by the target media content as clothing).

In this embodiment, the media content image of the target media content may display an image of the target object, such as a two-dimensional image or a three-dimensional image of the target object. Different media content images in the target media content may correspond to images of the target object under different display angles. For example, as the target media content is displayed, the display angle of the target object may change sequentially according to a preset order, so as to present a visual effect that the target object is rotating, and show the user images of the target object under different display angles.

In some implementations, the media content image of the target media content may display a three-dimensional image of the target object, and displaying the target media content on the media content display page may include switching to display different media content images of the target media content on the media content display page, where the different media content images correspond to different display angles of the three-dimensional image.

In some embodiments, the target object may be considered as an object recommended in the target media content. The target object may be a wearable object. For example, the target object may be an item such as clothing.

Specifically, when displaying the target media content in the media content, different media content images of the target media content may be switched, to display the three-dimensional image of the target object from different display angles to the current user. Taking the target media content as a video for an example, the target media content may be configured to present the frame that the three-dimensional image of the target object rotates in a configured direction. Thus, as the target media content plays, the displayed three-dimensional image of the target object may present a visual effect of rotating in the configured direction on the media content display page, thereby showing the user object details of the target object from different display angles such as front, side, and back.

In the above implementations, after displaying the image of the target object, the user may be supported to adjust the display angle of the target object. For example, when the target media content is the three-dimensional image of the target object, the user may be supported to adjust the display angle of the target object by dragging the three-dimensional image to rotate. When the target media content is media content, such as video, pictures and texts, or a combination of the two, which presents the frame of the three-dimensional image of the target object, the user may be supported to adjust the display angle of the target object by adjusting the display progress of the target media content.

In this case, optionally, the three-dimensional image of the target object may be displayed in the media content image of the target media content, and after displaying the target media content on the media content display page, the method may further include: in response to a second rotation operation for the three-dimensional image, controlling the three-dimensional image to rotate in a second rotation direction, where the second rotation direction is a rotation direction corresponding to the second rotation operation.

In some embodiments, the second rotation operation may be an operation for controlling the rotation of the three-dimensional image of the target object displayed on the media content display page, such as an operation of adjusting the display progress of the target media content or an operation of dragging the three-dimensional image of the target object to rotate. The second rotation direction may be a rotation direction corresponding to the second rotation operation, in other words, a direction of rotation indicated by the second rotation operation.

For example, when the second rotation operation for the three-dimensional image of the target object is received, the three-dimensional image may be controlled to rotate in the second rotation direction corresponding to the second rotation operation, so as to switch the current display angle of the three-dimensional image on the media content display page.

At block S102, in response to a try-on operation for the target object in the target media content, first appearance information to be tried on is obtained, and a first human body model whose appearance information matches the first appearance information is obtained, where the target object is a recommended object of the target media content.

In some embodiments, the try-on operation may be an operation configured to instruct to display a try-on image of the target object, such as an operation for triggering a try-on control displayed on the media content display page.

The first appearance information may be appearance information to be currently tried on, such as appearance information input by the current user or default appearance information pre-stored in the current application, etc. The first appearance information may be configured to describe appearance characteristics when trying on the target object currently. Optionally, the first appearance information includes at least one of height information, weight information, or body type information. The body type information may be configured to describe the body shape, which may be, for example, pear shape, inverted triangle shape, rectangle shape, hourglass shape, or apple shape. For example, the first appearance information may include body type information to improve the degree of matching between the obtained human body model and the actual appearance to be tried on.

The first human body model may be a virtual human body model whose appearance information matches the first appearance information, such as a virtual human body model generated based on the first appearance information. For example, the first human body model may be an artificial intelligence (AI) model. The appearance information of the first human body model may match the first appearance information, for example, the appearance information of the first human body model may be the same as the first appearance information, or may be obtained by processing the first appearance information, such as scaling or AI processing of the first appearance information.

Specifically, when the try-on operation for the target object in the target media content is received, for example, when it is detected that the current user triggers a try-on control 20 (as shown in FIG. 2) displayed on the media content display page, the first appearance information to be currently tried on may be obtained, and the first human body model whose appearance information matches the first appearance information may be obtained.

In this embodiment, when obtaining the first appearance information to be tried on, an appearance information input panel may be displayed, and appearance information input by the current user in the appearance information input panel may be obtained as the first appearance information to be currently tried on. It is also possible to obtain certain appearance information (such as default selected appearance information) pre-stored in the current application as the first appearance information to be currently tried on. In this case, optionally, obtaining the first appearance information to be tried on includes: displaying the appearance information input panel, where the appearance information input panel is configured to input the first appearance information; and in response to an input completion operation performed within the appearance information input panel, obtaining the first appearance information input by the current user in the appearance information input panel; or obtaining the pre-stored first appearance information.

In some embodiments, the appearance information input panel may be a panel used for the current user to input appearance information when trying on the target object. The input completion operation may be a trigger operation configured to instruct that the input of the appearance information is complete, such as an operation of triggering a save control in the appearance information input panel.

In some possible implementations, when the appearance information has been preset and saved in the current application, certain pre-saved appearance information may be obtained as the first appearance information. When no appearance information is pre-saved in the current application, the appearance information input panel may be displayed for the current user to input the appearance information.

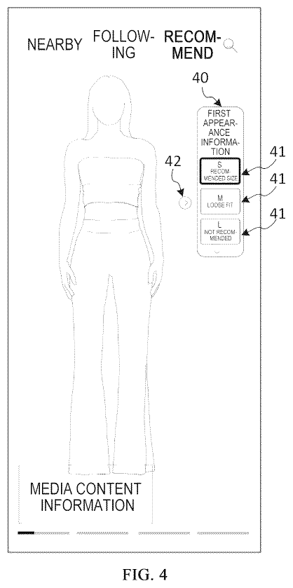

For example, when the try-on operation for the target object is received, it may be determined whether the appearance information is pre-stored in the current application. If there is the appearance information pre-stored in the current application, certain stored appearance information may be obtained as the first appearance information. If there is no appearance information pre-stored in the current application, as shown in FIG. 3, the appearance information input panel 30 may be displayed, for the current user to input the appearance information when trying on the target object in the appearance information input panel 30. When the input completion operation performed within the appearance information input panel 30 is received, for example, when it is detected that the current user triggers a save control 31 displayed in the appearance information input panel 30, the appearance information input by the current user in the appearance information input panel 30 may be obtained as the first appearance information.

Continuing to refer to FIG. 3, the appearance information input panel may display at least one appearance information input item, such as a height information input item, a weight information input item, and a body type information input item, for the current user to input height information, weight information, and/or body type information to be tried on. The input manner of each information is not limited, for example, the corresponding information may be input by character input, or by selecting the corresponding option displayed in the appearance information input panel.

In this embodiment, the manner for obtaining the first human body model matching the first appearance information may be flexibly set. For example, from among human body models stored in the server, a human body model with the highest degree of matching between its appearance information and the first appearance information to be tried on may be obtained as the first human body model matching the first appearance information. Optionally, the first appearance information may be sent to the server, the human body model may be generated by the server based on the first appearance information, and the human body model generated by the server may be obtained as the first human body model matching the first appearance information, so as to further improve the degree of matching between the appearance information of the first human body model and the first appearance information to be tried on.

It may be understood that the first appearance information may be the actual appearance information of the current user, or may be the appearance information of others set by the current user, such as the appearance information of the relatives or friends of the current user, so as to meet the needs of the current user to try on or purchase the target object for others.

At block S103, the first human body model is displayed on the media content display page, where the first human body model wears the target object.

For example, after the first human body model whose appearance information matches the first appearance information is obtained, the first human body model wearing the target object may be displayed. For example, the target object may be worn on the corresponding part of the first human body model, and the first human body model after wearing the target object is displayed, as illustrated in FIG. 4 (where facial features of the first human body model are not illustrated) for the current user to view the try-on effect of the target object.

In this embodiment, when the first human body model wearing the target object is initially displayed in response to the try-on operation of the current user for the target object, the size of the target object worn by the first human body model may be set according to needs. For example, the first human body model may wear a target object of a preset size; or the first human body model may wear a target object of a target size corresponding to the first appearance, so as to further improve the try-on effect of the target object. In this case, optionally, the first human body model wearing the target object may include: the first human body model wearing the target object of a target size, where the target size corresponds to the first appearance information. In some embodiments, the target size may be a size corresponding to the first appearance information, such as a size recommended for the user to try on when the appearance information to be tried on is the first appearance information.

According to the method for interaction provided by this embodiment, the target media content is displayed on the media content display page, in response to the try-on operation for the target object in the target media content, the first appearance information to be tried on is obtained, and the first human body model whose appearance information matches the first appearance information is obtained, where the target object is the recommended object of the target media content, and the first human body model wearing the target object is displayed on the media content display page. With the technical solutions described above, this embodiment supports the user to try on the recommended object included in the media content in the media content display page when viewing the media content, so as to view the try-on effect of the target object, which may enrich the display manners of information of the recommended object, simplify the operations required for trying on the recommended object, and provide convenience for the user to continue viewing the media content on the media content display page.

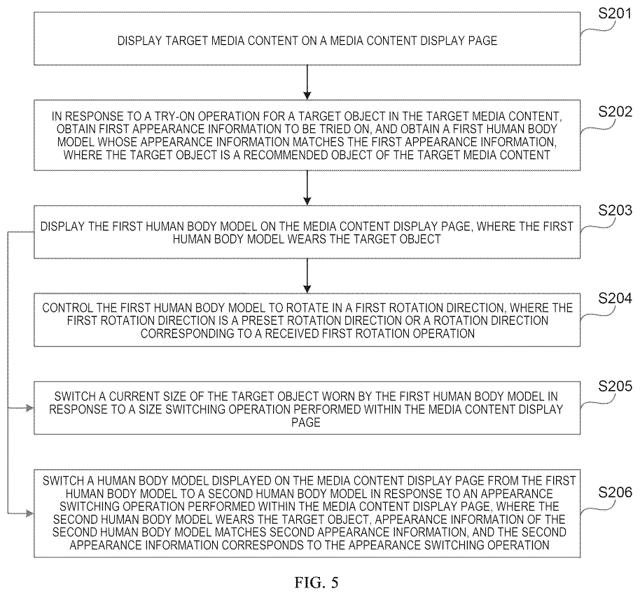

FIG. 5 is a schematic flowchart of a method for interaction according to a further embodiment of the present disclosure. The solutions in this embodiment may be combined with one or more optional solutions in the above embodiments. Optionally, after displaying the first human body model on the media content display page, the method further includes at least one of: controlling the first human body model to rotate in a first rotation direction, where the first rotation direction is a preset rotation direction or a rotation direction corresponding to a received first rotation operation; switching a current size of the target object worn by the first human body model in response to a size switching operation performed within the media content display page; or switching a human body model displayed on the media content display page from the first human body model to a second human body model in response to an appearance switching operation performed within the media content display page, where the second human body model wears the target object, appearance information of the second human body model matches second appearance information, and the second appearance information corresponds to the appearance switching operation.

Accordingly, as shown in FIG. 5, the method for interaction provided by this embodiment may include the following steps.

At block S201, target media content may be displayed on the media content display page.

At block S202, in response to a try-on operation for a target object in the target media content, first appearance information to be tried on is obtained, and a first human body model whose appearance information matches the first appearance information is obtained, where the target object is a recommended object of the target media content.

At block S203, the first human body model is displayed on the media content display page, and at least one of steps S204-S206 is performed, where the first human body model wears the target object.

In this embodiment, the first human body model may be a two-dimensional model or a three-dimensional model, and the display manner of the first human body model on the media content display page is not limited. For example, when the first human body model is a two-dimensional model, a two-dimensional image of the first human body model may be displayed on the media content display page. When the first human body model is a three-dimensional model, a two-dimensional image or a three-dimensional image of the first human body model may be displayed on the media content display page.

At block S204, the first human body model may be controlled to rotate in a first rotation direction, where the first rotation direction is a preset rotation direction or a rotation direction corresponding to a received first rotation operation.

In this embodiment, when displaying the three-dimensional image of the first human body model on the media content display page, it supports controlling the first human body model to rotate, so as to facilitate the user to view try-on effects of the target object from different display angles.

In some embodiments, the first rotation direction may be a rotation direction when the first human body model is controlled to rotate, which may be a preset rotation direction or a rotation direction corresponding to the first rotation operation. The preset rotation direction may be considered as a preset rotation direction, such as clockwise or counterclockwise. The first rotation operation may be an operation of controlling the first human body model to rotate, such as an operation of dragging the first human body model to rotate.

For example, after displaying the first human body model wearing the target object on the media content display page, the first human body model may be automatically controlled to rotate in the preset rotation direction. And/or, when the first rotation operation for the first human body model is received, the first human body model may be controlled to rotate in the rotation direction corresponding to the first rotation operation.

At block S205, a current size of the target object worn by the first human body model may be switched in response to a size switching operation performed within the media content display page.

In some embodiments, the size switching operation may be a trigger operation configured to instruct to switch the current size of the target object worn by the first human body model, such as an operation of triggering a size switching control or an operation of triggering a certain candidate size of the target object.

Specifically, when the size switching operation performed within the media content display page is received, the current size of the target object worn by the first human body model may be switched, for example, the current size of the target object worn by the first human body model may be switched to a size corresponding to the size switching operation, and the first human body model after switching the current size of the worn target object may be displayed.

In some implementations, displaying the first human body model on the media content display page includes: displaying on the media content display page the first human body model and a preset panel, where the preset panel displays the first appearance information and/or at least one candidate size identification of the target object, and the candidate size identification is configured to trigger execution of the size switching operation.

In the above implementations, when the first human body model wearing the target object is displayed, the preset panel may be further displayed on the media content display page, so as to facilitate the current user to determine the appearance information currently tried on and/or the size currently tried on.

In some embodiments, the candidate size identification may be understood as a size identification of a candidate size of the target object.

For example, as shown in FIG. 4, after the first human body model is obtained, the first human body model wearing the target object and the preset panel 40 may be displayed on the media content display page, the appearance information currently tried on (such as the first appearance information) and/or at least one candidate size identification 41 of the target object may be displayed in the preset panel 40, and the candidate size identification 41 corresponding to the size (such as the target size) currently tried on by the first human body model is displayed in a selected state. In addition, when displaying respective candidate size identifications 41, recommendation degree information and/or fitting effect information of the candidate size corresponding to each candidate size identification may be further displayed, so as to facilitate the user to quickly select the size to be tried on.

Therefore, when the current user intends to switch the current size tried on by the first human body model to a certain candidate size, he/she may trigger the candidate size identification 41 of that candidate size in the preset panel 40.

Accordingly, when detecting that the current user triggers a certain candidate size identification 41, the current application may determine that the size switching operation is received; and in response to the size switching operation, switch the current size of the target object tried on by the first human body model to the candidate size corresponding to the candidate size identification, and further switch the candidate size identification from an unselected state to a selected state.

At block S206, in response to an appearance switching operation performed within the media content display page, the human body model displayed on the media content display page is switched from the first human body model to a second human body model, where the second human body model wears the target object, appearance information of the second human body model matches second appearance information, and the second appearance information corresponds to the appearance switching operation.

In some embodiments, the appearance switching operation may be a trigger operation configured to instruct to switch the appearance information of the human body model for trying on, such as an operation of triggering an appearance switching control, or an operation of triggering certain appearance information input or saved by the current user. The second appearance information may be appearance information corresponding to the appearance switching operation, that is, appearance information instructed to switch to by the appearance switching operation, which may be appearance information input or pre-saved by the current user. The second human body model may be a human body model whose appearance information matches the second appearance information.

Specifically, when the appearance switching operation performed within the media content display page is received, the second appearance information corresponding to the appearance switching operation may be determined, the second human body model whose appearance information matches the second appearance information may be obtained, and the second human body model wearing the target object may be displayed on the media content display page.

Here, the size of the target object worn by the second human body model may be the preset size, the size of the target object worn by the first human body model before switching, or a recommended size corresponding to the second appearance information, which may be specifically set according to needs.

In some implementations, the user may perform the appearance switching operation through a candidate appearance panel. In this case, optionally, after displaying the first human body model and the preset panel on the media content display page, the method may further include: displaying a candidate appearance panel in response to a trigger operation for the first appearance information, where the candidate appearance panel displays at least one candidate appearance information pre-stored in a current application and an appearance switching control, and the appearance switching control is configured to trigger execution of the appearance switching operation.

In some embodiments, the candidate appearance panel may be a panel configured to display the candidate appearance information. The candidate appearance information may be appearance information pre-stored in the current application.

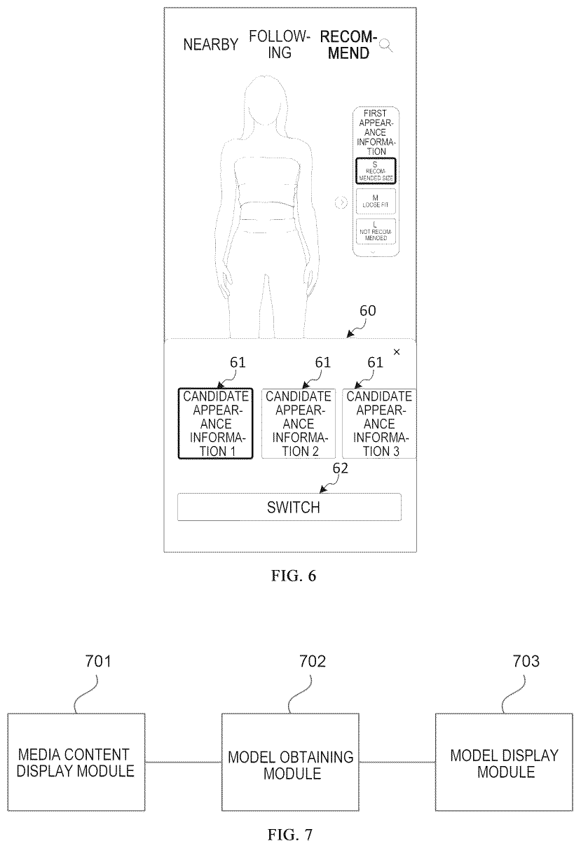

For example, as shown in FIG. 6, when it is detected that the current user triggers the appearance information (such as the first appearance information) displayed in the preset panel 40, the candidate appearance panel 60 may be displayed. At least one candidate appearance information 61, including the candidate appearance information displayed in the preset panel 40, and the appearance switching control 62 are displayed in the candidate appearance panel 60, and in the candidate appearance panel 60, the candidate appearance information 61 displayed in the preset panel 40 may be displayed in the selected state.

Therefore, the current user may select the candidate appearance information 61 (that is, the second appearance information) that he/she wants to switch to in the candidate appearance panel 60, and trigger the appearance switching control 62 in the candidate appearance panel 60 after the selection is completed.

Accordingly, when detecting that the current user triggers the appearance switching control 62 in the candidate appearance panel 60, the current application may determine that the appearance switching operation is received. In response to the appearance switching operation, the second human body model whose appearance information matches the candidate appearance information 61 selected by the current user in the candidate appearance panel 60 may be obtained, and the second human body model wearing the target object is displayed on the media content display page.

In this embodiment, the preset panel may have an expanded state and a collapsed state, so as to meet different needs of the user to view information in the preset panel or the human body model displayed on the media content display page. In this case, optionally, after displaying the first human body model and the preset panel on the media content display page, the method may further include: switching a display state of the preset panel on the media content display page in response to a state switching operation for the preset panel, where the display state includes an expanded state and/or a collapsed state.

In some embodiments, the state switching operation may be a trigger operation configured to instruct to switch the display state of the preset panel, such as an operation of triggering a state switching control displayed on the media content display page. The display size of the preset panel in the collapsed state is smaller than the display size in the expanded state.

As an example, when the state switching operation for the preset panel 40 is received, for example, when it is detected that the current user triggers the state switching control 42 (as shown in FIG. 4) displayed on the media content display page, if the preset panel 40 is in the expanded state, it may be switched from the expanded state to the collapsed state. If the preset panel 40 is in the collapsed state, it may be switched from the collapsed state to the expanded state.

According to the method for interaction provided by this embodiment, the user is supported to view the try-on effects of the target object from different display angles, and switch the appearance information currently tried on and/or the size information of the target object, which may further enrich the try-on manners of the target object and meet different try-on needs of the user.

FIG. 7 is a block diagram of an apparatus for interaction according to an embodiment of the present disclosure. The apparatus may be implemented by software and/or hardware, may be configured in an electronic device, typically in a mobile phone or a tablet computer, and may display a try-on effect of an item recommended in the media content in a media content display page by performing a method for interaction. As shown in FIG. 7, the apparatus for interaction provided by this embodiment may include a media content display module 701, a model obtaining module 702, and a model display module 703. The media content display module 701 is configured to display target media content on a media content display page. The model obtaining module 702 is configured to obtain first appearance information to be tried on in response to a try-on operation for a target object in the target media content, and obtain a first human body model whose appearance information matches the first appearance information, where the target object is a recommended object of the target media content. The model display module 703 is configured to display the first human body model on the media content display page, where the first human body model wears the target object.

According to the apparatus for interaction provided by this embodiment, the target media content is displayed on the media content display page by the media content display module, the first appearance information to be tried on and the first human body model whose appearance information matches the first appearance information are obtained by the model obtaining module in response to the try-on operation for the target object in the target media content, where the target object is the recommended object of the target media content, and the first human body model wearing the target object is displayed on the media content display page by the model display module. With the technical solutions described above, this embodiment may support the user to try on the recommended object included in the media content in the media content display page when viewing the media content, so as to view the try-on effect of the target object, which may enrich the display manners of information of the recommended object, simplify the operations required for trying on the recommended object, and provide convenience for the user to continue viewing the media content on the media content display page.

In the above solutions, the model obtaining module 702 may be configured to: display an appearance information input panel, where the appearance information input panel is configured to input the first appearance information; and in response to an input completion operation performed within the appearance information input panel, obtain the first appearance information input by a current user in the appearance information input panel; or obtain pre-stored first appearance information; where the first appearance information includes at least one of height information, weight information, or body type information.

Further, the apparatus for interaction provided by this embodiment may further include at least one of: a first rotation control module configured to control the first human body model to rotate in a first rotation direction after displaying the first human body model on the media content display page, where the first rotation direction is a preset rotation direction or a rotation direction corresponding to a received first rotation operation; a size switching module configured to, after displaying the first human body model on the media content display page, switch a current size of the target object worn by the first human body model, in response to a size switching operation performed within the media content display page; or an appearance switching module configured to, after displaying the first human body model on the media content display page, switch a human body model displayed on the media content display page from the first human body model to a second human body model in response to an appearance switching operation performed within the media content display page, where the second human body model wears the target object, appearance information of the second human body model matches second appearance information, and the second appearance information corresponds to the appearance switching operation.

In the above solutions, the model display module 703 may be configured to: display on the media content display page the first human body model and a preset panel, where the preset panel displays the first appearance information and/or at least one candidate size identification of the target object, and the candidate size identification is configured to trigger execution of the size switching operation.

Further, the apparatus for interaction provided by this embodiment may further include at least one of: a panel display module configured to, after displaying the first human body model and the preset panel on the media content display page, display a candidate appearance panel in response to a trigger operation for the first appearance information, where the candidate appearance panel displays at least one candidate appearance information pre-stored in the current application and an appearance switching control, and the appearance switching control is configured to trigger execution of the appearance switching operation; and a state switching module configured to, after displaying the first human body model and the preset panel on the media content display page, switch a display state of the preset panel on the media content display page in response to a state switching operation for the preset panel, where the display state includes an expanded state and/or a collapsed state.

In the above solutions, the first human body model wearing the target object may include: the first human body model wearing the target object of a target size, where the target size corresponds to the first appearance information.

In the above solutions, a three-dimensional image of the target object may be displayed in the media content image of the target media content, and the media content display module 701 may be configured to: switch to display different media content images of the target media content on the media content display page, where the different media content images correspond to different display angles of the three-dimensional image; and/or, the apparatus for interaction provided by this embodiment may further include: a second rotation control module configured to, after displaying the target media content on the media content display page, control the three-dimensional image to rotate in a second rotation direction in response to a second rotation operation for the three-dimensional image, where the second rotation direction is a rotation direction corresponding to the second rotation operation.

The apparatus for interaction provided by this embodiment of the present disclosure may execute the method for interaction provided by any embodiment of the present disclosure, and has corresponding functional modules and beneficial effects for executing the method for interaction. For technical details not described in detail in this embodiment, reference may be made to the method for interaction provided by any embodiment of the present disclosure.

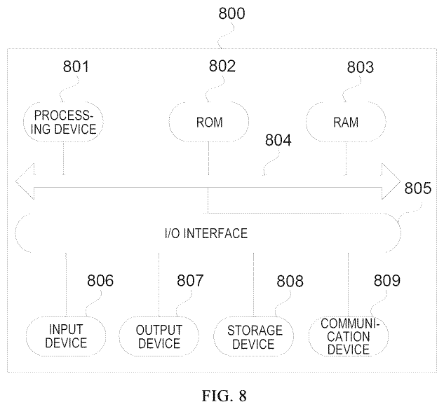

Reference is made to FIG. 8 below, which illustrates a schematic structural diagram of an electronic device 800 (such as a terminal device) suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 8 is only an example and should not impose any limitation on the function and scope of use of the embodiments of the present disclosure.

As shown in FIG. 8, the electronic device 800 may include a processing apparatus 801 (such as a central processing unit and a graphics processor), which may perform various appropriate actions and processing according to a program stored in a read-only memory (ROM) 802 or a program loaded from a storage apparatus 808 into a random access memory (RAM) 803. In the RAM 803, various programs and data required for the operation of the electronic device 800 are also stored. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a magnetic tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program codes for executing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the functions defined in the method of the embodiment of the present disclosure are executed.

It should be noted that the computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include a data signal propagated in a baseband or as a part of a carrier, and computer-readable program codes are carried in the data signal. The data signal propagated in this manner may be in multiple forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program codes contained on the computer-readable medium may be transmitted in any suitable medium, including but not limited to a wire, an optical cable, a radio frequency (RF), or any suitable combination thereof.

In some implementations, clients and servers may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The computer-readable medium carries one or more programs, and when the one or more programs are executed by the electronic device, the electronic device: displays target media content on a media content display page; in response to a try-on operation for a target object in the target media content, obtains first appearance information to be tried on, and obtains a first human body model whose appearance information matches the first appearance information, where the target object is a recommended object of the target media content; and displays the first human body model on the media content display page, where the first human body model wears the target object.

The computer program codes for performing the operations of the present disclosure may be written in one or more programming languages or a combination thereof, where the programming languages include but are not limited to object-oriented programming languages such as Java, Smalltalk, and C++, and further include conventional procedural programming languages such as “C” language or similar programming languages. The program codes may be executed entirely on a user's computer, partly on the user's computer, as a stand-alone software package, partly on the user's computer and partly on a remote computer, or entirely on the remote computer or a server. In the case of the remote computer, the remote computer may be connected to the user's computer through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented in software or hardware. The name of the module does not constitute a limitation on the unit itself under certain circumstances.

The functions described above may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more lines, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, Example 1 provides a method for interaction, including: displaying target media content on a media content display page; in response to a try-on operation for a target object in the target media content, obtaining first appearance information to be tried on, and obtaining a first human body model whose appearance information matches the first appearance information, where the target object is a recommended object of the target media content; and displaying the first human body model on the media content display page, where the first human body model wears the target object.

According to one or more embodiments of the present disclosure, Example 2 is according to the method of Example 1, where obtaining the first appearance information to be tried on includes: displaying an appearance information input panel, where the appearance information input panel is configured to input the first appearance information; and in response to an input completion operation performed within the appearance information input panel, obtaining the first appearance information input by a current user in the appearance information input panel; or obtaining pre-stored first appearance information; where the first appearance information includes at least one of height information, weight information, or body type information.

According to one or more embodiments of the present disclosure, Example 3 is according to the method of Example 1, after displaying the first human body model on the media content display page, the method further includes at least one of: controlling the first human body model to rotate in a first rotation direction, where the first rotation direction is a preset rotation direction or a rotation direction corresponding to a received first rotation operation; switching a current size of the target object worn by the first human body model in response to a size switching operation performed within the media content display page; or switching a human body model displayed on the media content display page from the first human body model to a second human body model in response to an appearance switching operation performed within the media content display page, where the second human body model wears the target object, appearance information of the second human body model matches second appearance information, and the second appearance information corresponds to the appearance switching operation.

According to one or more embodiments of the present disclosure, Example 4 is according to the method of Example 3, where displaying the first human body model on the media content display page includes: displaying on the media content display page the first human body model and a preset panel, where the preset panel displays the first appearance information and/or at least one candidate size identification of the target object, and the candidate size identification is configured to trigger execution of the size switching operation.

According to one or more embodiments of the present disclosure, Example 5 is according to the method of Example 4, after displaying the first human body model and the preset panel on the media content display page, the method further includes at least one of: displaying a candidate appearance panel in response to a trigger operation for the first appearance information, where the candidate appearance panel display at least one candidate appearance information pre-stored in a current application and an appearance switching control, and the appearance switching control is configured to trigger execution of the appearance switching operation; or switching a display state of the preset panel on the media content display page in response to a state switching operation for the preset panel, where the display state includes an expanded state and/or a collapsed state.

According to one or more embodiments of the present disclosure, Example 6 is according to the method of any of Examples 1-5, where the first human body model wearing the target object includes: the first human body model wearing the target object of a target size, where the target size corresponds to the first appearance information.

According to one or more embodiments of the present disclosure, Example 7 is according to the method of any of Examples 1-5, a three-dimensional image of the target object is displayed in a media content image of the target media content, and displaying the target media content on the media content display page includes: switching to display different media content images of the target media content on the media content display page, where the different media content images correspond to different display angles of the three-dimensional image; and/or after displaying the target media content on the media content display page, the method further includes: controlling the three-dimensional image to rotate in a second rotation direction in response to a second rotation operation for the three-dimensional image, where the second rotation direction is a rotation direction corresponding to the second rotation operation.

According to one or more embodiments of the present disclosure, Example 8 provides an apparatus for interaction, including: a media content display module configured to display target media content on a media content display page; a model obtaining module configured to, in response to a try-on operation for a target object in the target media content, obtain first appearance information to be tried on, and obtain a first human body model whose appearance information matches the first appearance information, where the target object is a recommended object of the target media content; and a model display module configured to display the first human body model on the media content display page, where the first human body model wears the target object.

According to one or more embodiments of the present disclosure, Example 9 provides an electronic device, including: one or more processors; and a memory, configured to store one or more programs, where the one or more programs, when executed by the one or more processors, cause the one or more processors to implement the method for interaction according to any of Examples 1 to 7.

According to one or more embodiments of the present disclosure, Example 10 provides a computer-readable storage medium, where a computer program is stored on the computer-readable storage medium, and the computer program, when executed by a processor, implements the method for interaction according to any of Examples 1 to 7.

According to the method, the apparatus, the electronic device, and the storage medium for interaction provided by the embodiments of the present disclosure, the target media content is displayed on the media content display page, in response to the try-on operation for the target object in the target media content, the first appearance information to be tried on is obtained, and the first human body model whose appearance information matches the first appearance information is obtained, where the target object is the recommended object of the target media content, and the first human body model wearing the target object is displayed on the media content display page. According to the technical solutions described above, the embodiments of the present disclosure support the user to try on the recommended object included in the media content in the media content display page when viewing the media content, so as to view the try-on effect of the target object, which may enrich the display manners of information of the recommended object, simplify the operations required for trying on the recommended object, and provide convenience for the user to continue viewing the media content in the media content display page.

The above description is only the preferred embodiments of the present disclosure, and an explanation of the technical principles employed. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosed concept. For example, a technical solution formed by replacing the above features with technical features with similar functions disclosed in the present disclosure (but not limited thereto) is also within the scope of the present disclosure.

Furthermore, although the operations are depicted in a particular order, this should not be understood as requiring the operations to be performed in the particular order shown or in a sequential order. Under certain circumstances, multitasking and parallel processing may be advantageous. Likewise, although the above discussion contains several specific implementation details, these should not be interpreted as limitations on the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only exemplary forms of implementing the claims.

1. A method for interaction comprising:
displaying target media content on a media content display page;
obtaining first appearance information to be tried on in response to a try-on operation for a target object in the target media content, and obtaining a first human body model whose appearance information matches the first appearance information, the target object being a recommended object of the target media content; and
displaying the first human body model on the media content display page, the first human body model wearing the target object.

2. The method of claim 1, wherein obtaining the first appearance information to be tried on comprises:
displaying an appearance information input panel, the appearance information input panel being configured to input the first appearance information; and obtaining the first appearance information input by a current user in the appearance information input panel in response to an input completion operation performed within the appearance information input panel; or
obtaining pre-stored first appearance information;
wherein the first appearance information comprises at least one of height information, weight information, or body type information.

3. The method of claim 1, wherein after displaying the first human body model on the media content display page, the method further comprises at least one of:
controlling the first human body model to rotate in a first rotation direction, the first rotation direction being a preset rotation direction or a rotation direction corresponding to a received first rotation operation;
switching a current size of the target object worn by the first human body model in response to a size switching operation performed within the media content display page; or
switching a human body model displayed on the media content display page from the first human body model to a second human body model in response to an appearance switching operation performed within the media content display page, the second human body model wearing the target object, appearance information of the second human body model matching second appearance information, and the second appearance information being corresponding to the appearance switching operation.

4. The method of claim 3, wherein displaying the first human body model on the media content display page comprises:
displaying, on the media content display page, the first human body model and a preset panel, the preset panel displaying the first appearance information and/or at least one candidate size identification of the target object, and the candidate size identification being configured to trigger execution of the size switching operation.

5. The method of claim 4, wherein after displaying on the media content display page the first human body model and the preset panel, the method further comprises at least one of:
displaying a candidate appearance panel in response to a trigger operation for the first appearance information, the candidate appearance panel displaying at least one candidate appearance information pre-stored in a current application and an appearance switching control, and the appearance switching control being configured to trigger execution of the appearance switching operation; or
switching a display state of the preset panel on the media content display page in response to a state switching operation for the preset panel, the display state comprising an expanded state and/or a collapsed state.

6. The method of claim 1, wherein the first human body model wearing the target object comprising:
the first human body model wearing the target object of a target size, the target size being corresponding to the first appearance information.

7. The method of claim 1, wherein a three-dimensional image of the target object is displayed in a media content image of the target media content, and displaying the target media content on the media content display page comprises:
switching to display different media content images of the target media content on the media content display page, the different media content images being corresponding to different display angles of the three-dimensional image; and/or
after displaying the target media content on the media content display page, the method further comprises:
controlling the three-dimensional image to rotate in a second rotation direction in response to a second rotation operation for the three-dimensional image, the second rotation direction being a rotation direction corresponding to the second rotation operation.

8. (canceled)

9. An electronic device, comprising:
at least one processor; and
a memory communicatively connected to the at least one processor;
wherein the memory stores a computer program executable by the at least one processor, and the computer program is executed by the at least one processor to enable the at least one processor to perform operations comprising:
displaying target media content on a media content display page;
obtaining first appearance information to be tried on in response to a try-on operation for a target object in the target media content, and obtaining a first human body model whose appearance information matches the first appearance information, the target object being a recommended object of the target media content; and
displaying the first human body model on the media content display page, the first human body model wearing the target object.

10. A non-transitory computer-readable storage medium having computer instructions stored thereon, and the computer instructions, when executed by a processor, performing operations comprising:
displaying target media content on a media content display page;
obtaining first appearance information to be tried on in response to a try-on operation for a target object in the target media content, and obtaining a first human body model whose appearance information matches the first appearance information, the target object being a recommended object of the target media content; and
displaying the first human body model on the media content display page, the first human body model wearing the target object.

11. The electronic device of claim 9, wherein obtaining the first appearance information to be tried on comprises:
displaying an appearance information input panel, the appearance information input panel being configured to input the first appearance information; and obtaining the first appearance information input by a current user in the appearance information input panel in response to an input completion operation performed within the appearance information input panel; or
obtaining pre-stored first appearance information;
wherein the first appearance information comprises at least one of height information, weight information, or body type information.

12. The electronic device of claim 9, wherein after displaying the first human body model on the media content display page, the operations further comprise at least one of:
controlling the first human body model to rotate in a first rotation direction, the first rotation direction being a preset rotation direction or a rotation direction corresponding to a received first rotation operation;
switching a current size of the target object worn by the first human body model in response to a size switching operation performed within the media content display page; or
switching a human body model displayed on the media content display page from the first human body model to a second human body model in response to an appearance switching operation performed within the media content display page, the second human body model wearing the target object, appearance information of the second human body model matching second appearance information, and the second appearance information being corresponding to the appearance switching operation.

13. The electronic device of claim 12, wherein displaying the first human body model on the media content display page comprises:
displaying, on the media content display page, the first human body model and a preset panel, the preset panel displaying the first appearance information and/or at least one candidate size identification of the target object, and the candidate size identification being configured to trigger execution of the size switching operation.

14. The electronic device of claim 13, wherein after displaying on the media content display page the first human body model and the preset panel, the operations further comprise at least one of:
displaying a candidate appearance panel in response to a trigger operation for the first appearance information, the candidate appearance panel displaying at least one candidate appearance information pre-stored in a current application and an appearance switching control, and the appearance switching control being configured to trigger execution of the appearance switching operation; or
switching a display state of the preset panel on the media content display page in response to a state switching operation for the preset panel, the display state comprising an expanded state and/or a collapsed state.

15. The electronic device of claim 9, wherein the first human body model wearing the target object comprising:
the first human body model wearing the target object of a target size, the target size being corresponding to the first appearance information.

16. The electronic device of claim 9, wherein a three-dimensional image of the target object is displayed in a media content image of the target media content, and displaying the target media content on the media content display page comprises:
switching to display different media content images of the target media content on the media content display page, the different media content images being corresponding to different display angles of the three-dimensional image; and/or
after displaying the target media content on the media content display page, the operations further comprise:
controlling the three-dimensional image to rotate in a second rotation direction in response to a second rotation operation for the three-dimensional image, the second rotation direction being a rotation direction corresponding to the second rotation operation.

17. The non-transitory computer-readable storage medium of claim 10, wherein obtaining the first appearance information to be tried on comprises:
displaying an appearance information input panel, the appearance information input panel being configured to input the first appearance information; and obtaining the first appearance information input by a current user in the appearance information input panel in response to an input completion operation performed within the appearance information input panel; or
obtaining pre-stored first appearance information;
wherein the first appearance information comprises at least one of height information, weight information, or body type information.

18. The non-transitory computer-readable storage medium of claim 10, wherein after displaying the first human body model on the media content display page, the operations further comprise at least one of:
controlling the first human body model to rotate in a first rotation direction, the first rotation direction being a preset rotation direction or a rotation direction corresponding to a received first rotation operation;
switching a current size of the target object worn by the first human body model in response to a size switching operation performed within the media content display page; or
switching a human body model displayed on the media content display page from the first human body model to a second human body model in response to an appearance switching operation performed within the media content display page, the second human body model wearing the target object, appearance information of the second human body model matching second appearance information, and the second appearance information being corresponding to the appearance switching operation.

19. The non-transitory computer-readable storage medium of claim 18, wherein displaying the first human body model on the media content display page comprises:
displaying, on the media content display page, the first human body model and a preset panel, the preset panel displaying the first appearance information and/or at least one candidate size identification of the target object, and the candidate size identification being configured to trigger execution of the size switching operation.

20. The non-transitory computer-readable storage medium of claim 19, wherein after displaying on the media content display page the first human body model and the preset panel, the operations further comprise at least one of:
displaying a candidate appearance panel in response to a trigger operation for the first appearance information, the candidate appearance panel displaying at least one candidate appearance information pre-stored in a current application and an appearance switching control, and the appearance switching control being configured to trigger execution of the appearance switching operation; or
switching a display state of the preset panel on the media content display page in response to a state switching operation for the preset panel, the display state comprising an expanded state and/or a collapsed state.

21. The non-transitory computer-readable storage medium of claim 10, wherein the first human body model wearing the target object comprising:
the first human body model wearing the target object of a target size, the target size being corresponding to the first appearance information.
